(19) United States
(12) Patent Application Publication
(10) Pub. No.: US 2026/0181237 A1
(43) Pub. Date: Jun. 25, 2026

(54) METHOD FOR SPECTRAL CALIBRATION OF A VISUALIZATION SYSTEM AND ASSOCIATED USE OF A VISUALIZATION SYSTEM

(71) Applicant: Schölly Fiberoptic GmbH, Denzlingen (DE)

(72) Inventors: Michael SCHWÄRZLE, Denzlingen (DE); Johannes BOURBON, Freiburg (DE)

(73) Assignee: Schölly Fiberoptic GmbH, Denzlingen (DE)

(21) Appl. No.: 19/419,423

(22) Filed: Dec. 15, 2025

(30) Foreign Application Priority Data
Dec. 20, 2024 (DE) 102024139284.3

(51) Int. Cl. H04N 23/50; G06T 7/80

(52) U.S. Cl. CPC H04N 23/555; G06T 7/80; G06T 11/10; G06T 2207/10024; G06T 2207/10068; G06T 2210/41

(57) ABSTRACT

A calibration method for a visualization system (1) is provided in order to improve the accuracy and reliability of subsequent subspectral image processing which can be used, for example, to obtain not only more broadband imaging but also additional image information which in turn is obtained exclusively from light which is in a subspectrum (2), wherein the subspectrum (2) is part of a spectrally broader total spectrum (3) used overall for imaging. The method provides for respective subspectral correction data (11) to be captured for individual wavelengths from the subspectrum (2) and stored in a memory (10), so that these correction data (11) can be taken into account in the subsequent subspectral imaging by the visualization system (1).

### CROSS-REFERENCE TO RELATED APPLICATIONS

This application claims priority from German Patent Application No. 10 2024 139 284.3, filed Dec. 20, 2024, which is incorporated herein by reference as if fully set forth.

### TECHNICAL FIELD

The invention relates to the technical field of visualization systems such as endoscopy or microscopy systems, in particular for medical applications, with which, for example, an operating area can be visualized in high resolution to a surgeon on a screen and in which a spectral analysis and processing of recorded image signal data or image data is carried out, typically in order to thus be able to visualize additional image information (such as an oxygen saturation of an observed tissue), which is referred to below as subspectral imaging/image signal processing. In addition to such a spectral measurement of oxygen in the blood, this approach also concerns, for example, the visualization of certain tissue types, wherein different spectral signal components are then also compared with each other as part of the image processing.

The invention deals more precisely with a method for setting up or calibrating a visualization system for such subsequent subspectral image processing and with a visualization system that can be used to implement such a method. In the subspectral image processing, (at least) a subspectrum (for example in the near infrared (NIR) and/or in the short wave infrared (SWIR) range and/or in the near ultraviolet (UV) wavelength range and/or in a part of the visible spectrum (VIS) in each case), as part of a total spectrum (e.g. full visible spectrum (VIS)+NIR) sensorily captured overall using the visualization system for imaging, is sensorily captured and processed in the form of (under certain circumstances respective) subspectral image signals (which are based only on the (respective) subspectrum) separately from the rest of the total spectrum. Processing here means that the subspectral image signals are subjected to processing (typically by an image processing unit of the visualization system, but this processing may also be moved to a cloud). This processing may be subspectral image processing, for example in order to generate subspectral image data such as fluorescence images; however, the processing may additionally or alternatively also be a calculation of a physiological variable (e.g. an oxygen saturation), for example in order to be able to visualize a spatial distribution of this variable (as “additional image information”).

Separately can mean here that the subspectral image signals are captured, for example, in a manner separated spatially (for example separated by a spectrally selective beam splitter) or temporally (for example with time-modulated illumination) from the rest of the total spectrum. Such approaches can make it possible, as stated, to calculate, from the subspectral image signals, additional image information which can then be superimposed, for example, on a white light image generated with the visualization system or, for example, can be displayed as a separate image to a user.

### BACKGROUND

In such applications of visualization systems, it is often problematic that, due to manufacturing tolerances, the spectral sensitivity (or the relative spectral loss) of the image transmission chain of the visualization system is subject to fluctuations, wherein the image transmission chain comprises not only optical components such as lenses, optical filters, beam splitters, mirrors and the like, but also electro-optical components such as the image sensor used. These fluctuations are either not sufficiently known or not known at all (which in both cases leads to incorrect calculations) or at least have to be kept very low in order to enable the desired subspectral image processing in a reliable form. In the latter case, therefore, there is often an attempt to keep the tolerances low using very complex manufacturing methods, and/or, for example, inappropriate filters or other components of the system are replaced, but both are complicated and thus expensive.

### SUMMARY

Based on this, the invention is based on the object of proposing a simpler and thus more cost-effective way of enabling more accurate and more reliable subspectral image processing in a visualization system as described at the outset, which can have a modular design in particular, despite considerable manufacturing tolerances.

To achieve this object, one or more of the features disclosed herein are provided in a calibration method according to the invention. In particular, it is thus provided according to the invention for achieving the object in a method of the type explained above that, in a calibration step, calibration light with (at least) a wavelength of the subspectrum and with a known intensity is sensorily captured in the form of subspectral measurement signals using the visualization system. The visualization system can comprise various individual components, each having different (e.g. manufacturing-related) tolerances.

Subspectral correction data can then be calculated (e.g. by a calculation unit of the visualization system, which can also be implemented in a cloud) from the subspectral measurement signals captured in this way, in particular taking reference signals into account. The subspectral correction data calculated in this way can then be stored in a memory (external memory or an internal memory of the visualization system) which can be read out (later) using the visualization system during the subsequent subspectral image processing. This means, in particular, that said correction data can be taken into account in the later calculation of the additional image information, with the result that the image information can be reliably determined with higher accuracy and, above all, independently of said manufacturing tolerances of the individual components.

As part of the actual subsequent subspectral image processing, the subspectral image signals can thus be processed (e.g. by a processing unit of the visualization system, which can also be implemented in a cloud) taking into account the correction data. This makes it possible to visualize image data of higher accuracy.

The (under certain circumstances respective) subspectrum can be understood here as a spectral section of the total spectrum used overall for imaging (=total spectral range used for imaging). The subspectral image signals are thus signal components that are generated by wavelengths in said subspectrum. These subspectral image signals can be sensorily captured, for example, using a separate image sensor, wherein a further (main) image sensor can capture the rest of the total spectrum (then without said subspectrum) or the entire total spectrum (then including the subspectrum).

Alternatively, only a single image sensor is used in the visualization system and this selectively captures the subspectrum at certain times, while at other times the image sensor captures the total spectrum (then together with the subspectrum) or only the remaining part of the total spectrum (without the subspectrum) (e.g. with temporarily changing illumination with white light and excitation light).

A further possible approach within the scope of the invention is to use an (e.g. hyperspectral) image sensor, with which the subspectrum can be sensorily captured (spatially) selectively, but at the same time as the rest of the total spectrum. Thus, the total spectrum can be spectrally divided into different color pixels of the image sensor which each capture a specific subspectrum, in which case these subspectra can also spectrally overlap.

In all such approaches, white light imaging can be realized with the visualization system, regardless of which sensor captures which spectral image signals; for this, it is only crucial that sufficient signal components in the visible wavelength range are captured as a whole.

The advantage of the approach according to the invention is, in particular, the fact that the subspectral correction data allow a conclusion to be drawn about the actual spectral relative sensitivity of the image recording system in the subspectral range used. Thus, if individual components of the image transmission chain of the visualization system show manufacturing-related fluctuations that affect the spectral sensitivity and thus lead to a falsification of the subspectral image signals, or if these components influence each other in an undesirable manner, these effects can be compensated with the aid of the subspectral correction data. In this case, the different components of the visualization system influence the calculated correction data which will therefore differ from system to system. The largest proportion of the fluctuation in the spectral sensitivity is typically attributable to the spectral filters used in the visualization system (e.g. interference filters in the imaging beam path or color filters at the pixel level of the respective image sensor) and their mutual dependencies.

The subspectral measurement signals/measurement data captured in the calibration step using the visualization system are thus ultimately intended to be used to correct image data or calculate them for the first time, which data are calculated in the subsequent subspectral imaging (typically by an image signal processing unit). This allows a spectral correction of this image signal processing in real time, which takes into account the spectral sensitivity of the visualization system used, as measured in the calibration step. This therefore enables subspectral visualizations with increased accuracy and reliability, which can improve, for example, a diagnosis or detection of a certain tissue type or the determination of a perfusion in each case within a certain operating area by a physician, wherein the physician in each case performs/carries out an assessment on the basis of the subspectral imaging. The method also offers significant practical advantages for the user.

Such a calibration method according to the invention can be carried out, for example, already during the production of the visualization system; alternatively, it is carried out by the user himself only in the specific application, e.g. in each case before starting up the visualization system, in which case color-variable light sources or special color charts can be used, for example, as targets for this purpose in order to generate suitable calibration light, as will be explained in yet more detail later.

Thus, for example, light sources with a specific spectral distribution, light sources with the possibility of specifically controlling or generating spectral areas (e.g. a plurality of lasers), and filters (for example in order to filter a subspectrum out of the light emitted by a light source) can be used to generate calibration light. The respective calibration light may, but need not necessarily, overlap the subspectrum to be corrected. This is because, for example, it may be advantageous not to cover the subspectrum to be corrected, which is intended to be used to calculate the subspectral imaging, by means of the calibration light, but rather to move the calibration light into a neighboring subspectrum, for example. This is because this makes it possible to capture a parasitic signal (e.g. resulting from crosstalk), the influence of which can be taken into account later in the subspectral imaging by means of the subspectral correction data, more precisely by means of a parasitic correction value.

A combination of these approaches is also conceivable: For example, a calibration with a high resolution (approximately 5 nm) can be carried out during production, whereas the subspectral correction data stored, for example, as a correction curve are then only checked or adapted during the actual use due to significantly fewer supporting points/measurement signals which can be captured comparatively easily, for example, with color maps. For example, aging or temperature effects or other drifts that arise during use can be efficiently compensated. The subspectral correction data captured once can therefore be newly captured or adapted from time to time.

It can therefore be characteristic of the calibration light—in particular in contrast to more broadband illumination light (which may also include excitation wavelengths, for example in fluorescence imaging) which is used later in the actual imaging—that the calibration light is exclusively or predominantly in the subspectrum or, for example, predominantly closely adjacent to the subspectrum.

However, it is not absolutely necessary here for the calibration light to include all wavelengths of the subspectrum which are later captured as subspectral image signals and are used for subspectral imaging. This is because, for example, it is also possible to use only one or more individual wavelengths from the subspectrum as the (under certain circumstances respective) calibration light. The measurement signals obtained in this way can be used specifically—for example on the basis of certain hypotheses—as supporting points in order to adapt an assumed spectral sensitivity curve of the visualization system in the subspectrum, i.e. to calculate corresponding subspectral correction data. In other words, the correction data can be stored, for example, in the form of a spectral sensitivity curve, from which a respective correction value can be calculated for different wavelengths from the subspectrum.

In contrast to a conventional white balance, the calibration light used is typically not white light and is therefore not broadband and does not cover the entire visible wavelength range used for VIS imaging, but rather only the subspectrum or at least part of it, or it is at least a spectrally limited wavelength range which, for example, is closely adjacent to the subspectrum. As mentioned, the subspectrum can lie, in particular, in the non-visible wavelength range, for example in the NIR or near UV or SWIR. In addition, the calibration light can also lie outside the subspectrum to be calibrated, as mentioned, in order to also capture parasitic signals and, if necessary, to suppress them or to be able to take them into account/remove them when calculating the subspectral image signals.

However, the situation may also arise in which broadband light, in particular white light, is used as calibration light. In this case, a comparison can be made against predetermined conditions: For example, it is possible to specify which signal ratios should result between different color channels of the visualization system. Accordingly, correction factors can then be determined as subspectral correction data in order to also actually achieve these desired signal ratios in the subsequent imaging. The difference to the white balance in such a case is that the subspectra do not only relate to colors that are used for white light representation/direct representation, but, in particular exclusively, to spectral ranges or colors that are not used for direct visual representation, but are sensorily captured only for the purpose of calculating subspectral image information, for example in order to visualize a certain physiological measured value (usually in addition to a white light image).

Another difference may be that a calculation of the subspectral correction data may differ from a calculation of a color matrix used for a white balance.

Suitable monochromators, narrowband light sources such as lasers or LEDs, or, for example, spectrally precisely defined light sources such as Hg lamps can be used, for example, to generate the calibration light. Under certain circumstances, however, the calibration light used may also be more broadband than the subspectrum, i.e. than the spectral range or the spectral ranges which is/are subsequently captured and evaluated separately for the subspectral imaging. In this case, ideally at least one spectral intensity curve of the calibration light or at least the proportion of the intensity of the wavelengths falling into the subspectrum in relation to the total intensity of the calibration light (i.e. all wavelengths included in the calibration light) should then be known in order to be able to calculate the correction data correctly.

Furthermore, it is important to note at this point that the calibration light preferably thus comprises at least some or all of those wavelengths from the subspectrum which are sensorily captured as subspectral image signals in the subsequent spectral imaging using the visualization system (i.e. during actual use). This distinguishes the calibration light from, for example, excitation light which is used in fluorescence imaging, wherein, although the fluorescence light generated by means of excitation light in the tissue (at typically longer wavelengths than the excitation light) is sensorily captured for imaging, the excitation light itself is not, because this is removed from the image signal transmission chain by means of an optical excitation light filter. As already mentioned above, however, calibration light used for calibration can also lie outside the subspectrum, for example in order to obtain parasitic correction values in the calibration step.

Thus, if, for example, the visualization system is used in such a way that a fluorescence wavelength is sensorily captured in the subspectral imaging, the approach according to the invention provides for the calibration light to then comprise the fluorescence wavelength(s), preferably exclusively. However, the approach according to the invention not only allows suitable corrections in the fluorescence imaging, but also the compensation for errors caused by fluctuating absorption properties or fluctuating reflection or transmission.

Preferably, at least one calibration light used in the calibration step may be limited to the subspectrum, i.e. may only comprise wavelengths (of a significant intensity) that lie within the subspectrum. This can improve the accuracy when determining the subspectral correction data.

The correction data can be calculated, for example in the form of deviations, as individual spectral correction values (for individual wavelengths or wavelength ranges of the subspectrum) and/or stored in the memory.

In particular, the memory can be part of the visualization system. For example, such a memory may be formed in a camera head of the visualization system or in a camera control unit. It is furthermore also possible to implement the memory in a web-based manner, e.g. in a cloud, in which case the visualization system then accesses the cloud during or before start-up in order to retrieve the correction data. Even the calculation of the additional image information, taking the correction data into account, can be carried out in the cloud. In this case, even already completely processed image data from the cloud can be transmitted back to the visualization system, with the result that the correction data also do not have to be retrieved directly from the visualization system.

As mentioned, it is necessary to know the intensity of the calibration light used in order to correctly calculate the subspectral correction data. In this case, this intensity of the calibration light can be known in absolute terms or relative to other reference light which is also sensorily captured using the visualization system. This achieves the situation in which the stored respective correction value in the subsequent subspectral image processing actually corresponds to the spectral tolerances of the specific visualization system, which are at least indirectly determined, with the result that these tolerances can be effectively compensated and more accurate subspectral imaging is possible, without the need to laboriously measure or even replace individual optical components.

The approach according to the invention thus provides for the respective spectral characteristics/sensitivities of all relevant subcomponents of the complex visualization system to be sensorily captured, stored and taken into account in the subsequent subspectral visualization (i.e. the image generation with wavelengths from the subspectrum) together rather than individually.

The basic approach presented can also be improved by further advantageous configurations:

For example, it is fundamentally possible for the entire total spectrum or the remaining part of the total spectrum (=total spectrum minus subspectrum) to be sensorily captured using a first image sensor and for the subspectrum to be sensorily captured using a separate second image sensor.

However, it is also possible for the entire total spectrum (i.e. the subspectrum and the rest of the total spectrum) to be captured using the same image sensor. This can take place, for example, in a spatially separated manner in different pixels of the image sensor (for example when using a hyperspectral sensor) and/or temporally separately from each other at different times, with the result that in this way the subspectrum and the remaining part of the total spectrum can also each be separately captured. Temporally separated sensory capture can be achieved, for example, by means of switchable or moving optical filters in the image transmission chain or by means of time-modulated illumination during imaging, as is already known per se.

As part of the calibration step, a spectral characteristic of a light source of the visualization system can also be sensorily captured and stored together with the subspectral correction data. The capture can be effected with the aid of a separate measuring device or using the visualization system itself This makes it possible to achieve the situation in which this spectral characteristic can also be taken into account, when using the light source, in the subsequent subspectral imaging when processing the subspectral image signals. Thus, for example, a spectral radiation characteristic of the light source used can be measured as part of the calibration step (preferably over the entire illumination field) and can then be taken into account later in order to enable an improved spectral accuracy of the subspectral correction of the entire system in the subspectral imaging (at signal level).

The spectral transmission of optical filters or spectrally selective beam splitters can vary locally, in particular. For example, the transmission often heavily depends on the angle of incidence of the imaging beams that fall onto the respective spectrally selective optical surface, wherein the angle of incidence varies over the observed object field and thus also between different image areas. However, this can lead to the spectral sensitivity of the image transmission chain of the visualization system depending on the position of the respective picture element. In order to be able to better compensate for such effects, which can also be subject to manufacturing-related fluctuations, the invention can provide, in particular, for the subspectral correction data to be captured or calculated in a spatially resolved manner for different image areas and/or for different picture elements and stored in the form of location-dependent correction data. Of course, it is preferred if different subspectral correction values (depending on the location) are taken into account for different picture elements in the subsequent subspectral image processing, for example even at the same wavelength from the subspectrum. It should also be mentioned that the location-dependent correction values can also be calculated by simple interpolation, with the result that these do not necessarily have to be captured and/or stored for each pixel.

This approach thus allows a spatially resolved spectral correction of the spectral sensitivity of the visualization system. In particular, this can ensure that an optimized spectral and spatially resolved correction can be carried out in each case in an entire visual range of the visualization system. The correction data can thus include spatially resolved correction values. Such a spatially resolved subspectral correction may also be useful for carrying out the calibration not only for different wavelength ranges and/or different image areas, but also for different pixel ranges of the (at least one) image sensor used, so as to be able to effectively compensate for spatial variations in the spectral sensitivity of the image sensor used.

The approach of the invention constitutes a departure from previous approaches which attempt to optically measure and select the respective individual component (such as the image sensor, or a single specific filter) or, for example, to specify it within narrow limits and then implement it by means of complex production methods. Rather, in the method according to the invention, the entire image transmission chain is always used when capturing the calibration measurement signals. As a result, all system components involved, with their respective influence on the subspectral image signals, are taken into account at the same time, in which case this can be captured in a location-dependent manner, as mentioned.

A visualization system used in the method may comprise, for example, a camera head and a plurality of endoscopes that can be used with the camera head. In such a case, for each of these endoscopes, a separate subspectral correction data set can be sensorily captured and respectively stored for each of these endoscopes (for example in a memory of the camera head). As a result, when the respective endoscope with camera head is used later, an endoscope-specific spectral correction of the subspectral image signals can be carried out.

In the method according to the invention, all components of the visualization system, which are used in later/subsequent subspectral imaging, are also preferably used to capture the subspectral measurement signals with the aid of the calibration light and/or a suitable calibration target. This distinguishes the approach according to the invention from previously known approaches which attempt to optically measure the respective individual component and to obtain correction data therefrom or, for example, to make tolerances very narrow. Another possible difference is that for example separate measuring devices are not used in the calibration, but rather the subspectral measurement signals are captured using an image sensor of the visualization system, which receives imaging light from an optical imaging system of the visualization system.

The subspectral correction data can also cover at least two different spectral ranges within the subspectrum. In such a case, the respective correction data in the least two ranges may differ in terms of their respective spectral resolution (measured in nm). Such a procedure can be beneficial in order to save memory space or computing power while still enabling an optimized spectral correction. The spectral resolution used for individual ranges of the subspectrum during calibration can therefore be selected differently/with gradation.

A further configuration of the method provides, in the calibration step, for respective correction data to be generated for at least two different subspectra (which are intended to be sensorily captured and processed later, in particular temporally and/or spatially separately from each other, as part of the subspectral image processing). In such a case, it may be sufficient, for example, if this takes place on the basis of at least a ratio of two subspectral measurement signals which are sensorily captured in the at least two different subspectra in the calibration step using the visualization system. In other words, the correction data for the at least two subspectra are therefore determined/calculated here by considering the respective ratio of the two subspectral measurement signals.

Yet another configuration serves to compensate for parasitic subspectral image signals which can arise in particular through spectral crosstalk: For this purpose, provision may be made for the correction data to comprise a parasitic correction value which can/will be used in the subsequent subspectral image processing in order to compensate for a parasitic subspectral image signal. Calibration light which is spectrally outside that subspectrum (to be corrected), during the subsequent processing of which (as part of the subspectral image processing, in particular subspectral imaging) the parasitic correction value is taken into account, can be sensorily captured for this purpose in the calibration step. Such a correction of a parasitic subspectral image signal can be used to eliminate that signal component which should not actually appear in the subspectrum, but is caused by manufacturing tolerances and resulting spectral crosstalk. This component can be subtracted with a certain factor (which can be expressed by the parasitic correction value), in particular on the basis of an intensity of the subspectrum or the sensorily captured total spectrum or the sensorily captured rest of the total spectrum.

The calibration light, which is used during the calibration step, can be generated, for example, by means of a plurality of time-modulated calibration light sources or, for example, by means of a spectrally modulatable light source or by means of a broadband light source in conjunction with a plurality of different targets. Such targets can be realized, for example, in the form of color maps and then show different spectral reflection or transmission properties (in the case of spectral filtering), as a result of which spectrally different calibration light can also be generated for the calibration measurements.

The visualization system may also be configured in such a way that it allows a plurality of subspectral imaging modes, for example in at least two different subspectra. In such a case, a respective subspectral correction data set can then be captured and stored for each of these subspectra.

For achieving the object and in particular for using the correction data determined using a method according to the invention, a specific use of a visualization system, which can be configured in particular as explained above, is also provided. This visualization system can therefore comprise in particular a camera head and at least one associated endoscope. The use provides for the visualization system to be used for subspectral imaging (as explained above), said imaging being carried out at the same time as or in temporal alternation with further spectrally broader imaging (this may be in particular white light imaging in the visible wavelength range) which is also carried out using the visualization system. The use is now distinguished by the fact that subspectral image signals generated during the subspectral imaging using the visualization system are corrected with the aid of subspectral correction data measured by a calibration method, which method is configured according to the invention, i.e. in particular as described above or as noted in the description and claims that follow directed to a method. Here, it is advantageous for optimal calibration if the subspectral image signals are based only (i.e. exclusively) on a subspectrum as part of the spectrally broader total spectrum used overall for imaging and/or represent this subspectrum.

This use can also be developed further: For example, provision may be made for different subspectral correction values to be applied when correcting the subspectral image signals depending on the location. This can take place in particular in such a way that a subspectral correction of varying degrees is made over a subspectral image which is (just) captured using the visualization system. The correction can therefore be different, in particular depending on the position of a picture element associated with the respective subspectral image signal.

In the use, provision may also be made for the stored subspectral correction data to be called when correcting the subspectral image signals and to then be processed further by means of interpolation or extrapolation and/or taking into account a current measured value of an environmental factor (for example an ambient temperature) to form an extended and/or adapted correction data set (this further processing can be automatically carried out, for example, by an image processing unit of the visualization system), wherein the correction data set extended/adapted in this manner is then used for the subspectral correction.

Finally, the invention also provides a visualization system having one or more of the features disclosed herein which can be equipped and set up in such a way that the previously described methods can be implemented using this visualization system. The visualization system comprises a calculation unit, a processing unit and at least one image sensor, and preferably a camera head (which then carries the at least one image sensor) and at least one associated endoscope (in particular without an image sensor) (which can be used with the camera head for imaging). The system is distinguished by the fact that the calculation unit is configured, in a calibration step, to calculate subspectral correction data from subspectral measurement signals based on sensory capture of calibration light (in particular provided as described above in detail). In order to achieve the object, provision is also made for the processing unit to be configured to process subspectral image signals from the at least one image sensor (in particular as described above in connection with the method) in an imaging mode, taking into account the correction data, for instance in order to generate subspectral images from the image signals or to calculate a spatial distribution of a physiological variable, as explained in detail at the outset. In this way, the system can achieve improved (since spectrally corrected) subspectral imaging and/or a more accurate calculation of additional image information.

It is particularly preferred for numerous applications if the processing unit is configured to process the subspectral image signals in real time and the visualization system is also set up, in addition to and at the same time as the processing of the subspectral image signals, to also generate live white light images from signals from the at least one image sensor, in particular so that the white light images can be visualized by the system on a display unit together with the subspectral images and/or the additional image information.

### BRIEF DESCRIPTION OF THE DRAWINGS

The invention will now be described in more detail on the basis of exemplary embodiments, but is not restricted to these exemplary embodiments. Further embodiments of the invention can be obtained from the following description of a preferred exemplary embodiment in conjunction with the general description, the claims, and the drawings.

In the following description of various preferred embodiments of the invention, elements that correspond in terms of their function are denoted by corresponding reference numerals, even in the case of a deviating design or shape.

In the drawings:

FIG. 1 shows a schematic representation illustrating the temporal sequence of the performance of a calibration method according to the invention,

FIG. 2 shows the calculation of (digital) subspectral correction data on the basis of subspectral measurement signals measured using the visualization system,

FIG. 3 shows a flowchart for illustrating the calculation of said correction data,

FIG. 4 shows a further possible configuration of a calibration method according to the invention, wherein three spectrally different time-modulated calibration light sources are used here,

FIG. 5 shows a further example of how a calibration method according to the invention can be effected by means of only a single calibration light source which provides continuous broadband illumination,

FIG. 6 shows a possible modification of a calibration method according to the invention when using a plurality of image sensors,

FIG. 7 shows the calculation of location-related spectral correction values and finally

FIG. 8 shows the use of spectral correction data determined according to the invention for the correction of image signals captured as part of subspectral imaging using the visualization system.

### DETAILED DESCRIPTION

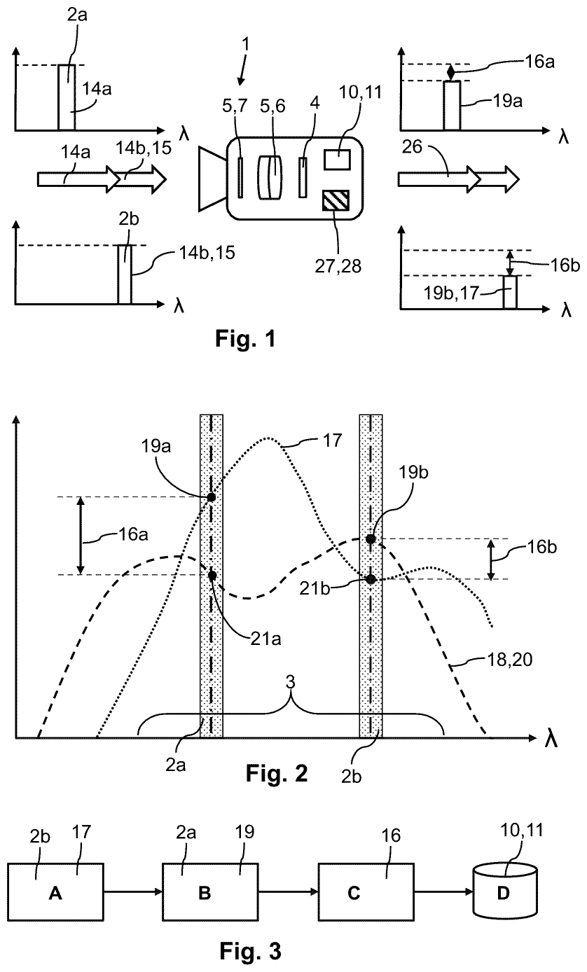

FIG. 1 shows a visualization system 1 which comprises a camera head and an associated endoscope. However, the drawing shows only the camera head which has an image sensor 4, a plurality of optical lenses 6 and, as a further passive optical component 5, an optical filter 7 which can be used to filter out certain wavelengths. In addition, the visualization system 1 also comprises a calculation unit 27 for calculating correction data 11 and a processing unit 28 which can be used to process subspectral image signals in real time taking into account the correction data 11. Depending on the type of additional image information which is intended to be created by processing the subspectral image signals, the processing unit 28 can be configured in particular as an image processing unit. In the latter case, the processing unit 28 thus generates a visual representation (“subspectral representation”) from the subspectral image signals corrected by means of the correction data 11. The arrangement of the units 27 and 28 is largely arbitrary; the units 27 and 28 can even be moved to a cloud within the scope of the invention.

Depending on the illumination used, a comparatively broadband total spectrum 3 (compare FIG. 2) can be sensorily captured with the image sensor 4 using this visualization system 1 in order to thus enable white light imaging (VIS). In addition, however, it is also possible to capture spectrally narrower different subspectra 2a and 2b and thus subspectral image signals with the image sensor 4, for example selectively in time with alternating illumination. As FIG. 2 shows, these subspectra 2a, 2b lie within the entire sensorily captured total spectrum 3.

For example, the subspectrum 2b could correspond to a fluorescence wavelength range which can be sensorily captured separately with the image sensor 4. In the case of such separate sensory capture of the subspectrum 2b, subspectral image signals 26 are generated by a processing unit 28 of the visualization system 1, from which subspectral images and/or additional image information can be calculated/generated. In particular, with such an approach, for example with time-modulated illumination, additional image information such as a fluorescence image or a spatial distribution of a physiological measurement variable can be obtained from the sensorily captured subspectrum 2a and/or 2b and can then be superimposed on the white light image (sensorily captured at other times), for example in the form of an “image overlay”.

In order to improve the calculation of such a subspectral image 25 (which is thus based only on a limited proportion of wavelengths from the total spectrum 3 which is used overall for imaging), the invention provides carrying out a calibration step, even before the visualization system 1 is actually used as part of imaging, in which, as shown in FIG. 1, calibration light 14 with a wavelength within the respective subspectrum 2 and with a known intensity is sensorily captured using the visualization system 1 (measurement signals or image signals 26 are then thus also recorded as part of a calibration and can be understood as calibration image signals).

In addition, however, it is also possible to use calibration light 14 which is outside the respective subspectrum 2 in order to check whether there are parasitic signal components that should not actually be present and should therefore be eliminated in the subsequent subspectral imaging (by means of corresponding parasitic correction values as part of the correction data 11). This approach can therefore be used to compensate for a parasitic subspectral image signal.

Thus, the left half of FIG. 1 respectively (schematically) shows graphs showing the intensity of the respective light 14, 15 and the respective wavelength λ (=intensity distribution). In contrast, the right side of FIG. 1 shows the respective measurement signals 26 (calibration image signals) in which the respective light 14, 15 results. The signal strength of measurement signals 26 captured with the image sensor 4 of the visualization system 1 as part of the calibration step is thus shown in the right graph, and the upper graph shows the subspectral measurement signals 19 resulting from the previously used calibration light 14 from the wavelength range 2a. The calculation unit 27 of the visualization system 1 uses the subspectral measurement signals 19 captured in this way to calculate corresponding subspectral correction data 11 which can be stored in a memory 10, for example in the form of individual correction values 16. This has the advantage that the processing unit 28 then reads out and considers these subspectral correction data 11 in the subspectral image processing during the subsequent actual use of the visualization system 1, as a result of which subspectral images 25 of better accuracy and higher reliability can be obtained. In particular, the correction data 11 can thus be taken into account in the calculation of additional image information, such as an oxygen saturation, which is determined from the subspectral image signal processing. This makes it possible to compensate for manufacturing-related fluctuations in the spectral sensitivity of the visualization system 1.

In this calibration method, as shown in FIG. 1, reference light 15 (used to illuminate an observed scene) can also be sensorily captured using the visualization system 1, wherein the subspectral correction data 11 can then be calculated taking into account reference signals or reference measured values (these are also image or measurement signals 26) based on the reference light 15. This approach has the advantage that ratios of the captured reference signals, in particular for different intensities of the reference light 15 and/or for an entire illumination field used for imaging, can thereby be stored as correction data. Such correction data according to the invention then allow the respective measurement variable to be determined more accurately. In addition, such a “reference light calibration” makes it possible to determine more precisely changes in spectral conditions, as result from the reference measured values, and thus to use them to more accurately determine the respective target measurement variables, i.e. to incorporate them in the respective correction carried out.

FIG. 3 again schematically summarizes the steps explained above: In step A, for example, said reference wavelength range 2b can be measured using the image recording system 1, with the result that, in a subsequent step B, after the actual subspectrum 2a has been sensorily captured, corresponding correction values 16 can be determined as subspectral correction data 11 in the subsequent step C by comparing the measurement signals 19 based on the subspectrum 2a with the previously captured reference measured values 17 and can be stored in the mentioned memory 10 in the subsequent step D. Such a memory 10 can be implemented, for example, by means of an electronic mass storage device, an internal memory of the camera head or in a web-based manner, for example in a cloud. It is only important that the visualization system 1 has access to the memory 10 during use in an imaging mode in order to thus be able to read out the correction data 11 and take them into account when processing the subspectral image signals (by way of the processing unit 28) in the imaging mode; alternatively, the correction data 11 (and possibly even the processing unit 28) are moved to the cloud and the additional image information is actually calculated in the cloud.

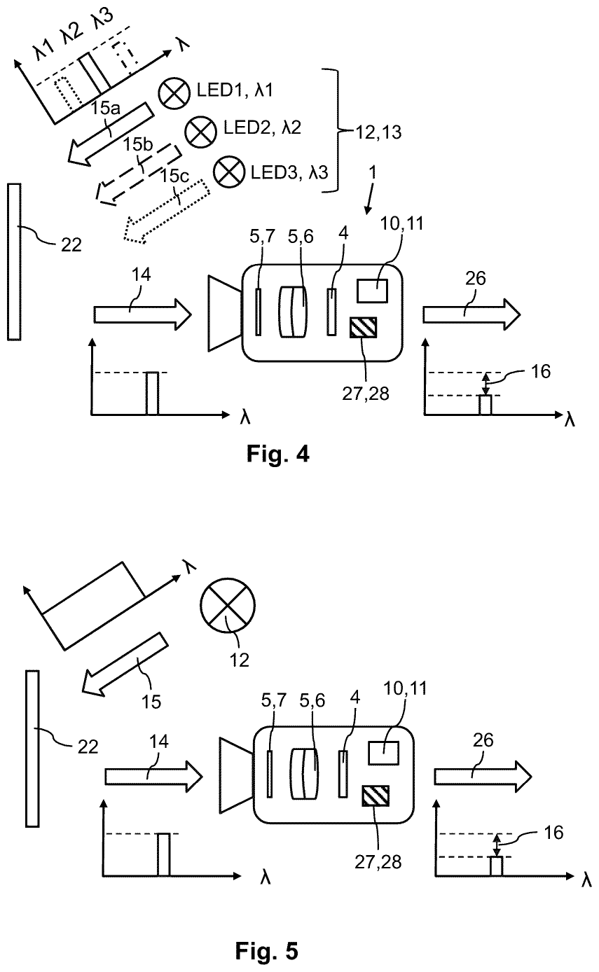

FIG. 4 shows a further approach according to the invention of how a calibration method according to the invention can also be carried out by using a plurality of calibration light sources 13 (shown here by way of example in the form of a plurality of LEDs, each emitting an average wavelength λᵢ and thus emitting respective illumination light 15 to a color map 22): The color map serving as a target 23 reflects the corresponding illumination light 15 in each case and thus sends, if necessary, calibration light 14 spectrally deviating from the reference light 15 in the direction of the image recording system 1 (since the target reflects individual wavelengths, but absorbs others). If the intensity of the respective illumination light 15 is known exactly (compare the left graph in FIG. 4), respective correction values 16 can be determined for the different wavelengths λ₁ to λ₃ and can be stored as subspectral correction data 11 in the memory 10.

In order to thus sensorily capture numerous supporting points within the relevant subspectrum 2 with the image sensor 4, it is helpful to capture in each case different calibration wavelengths λᵢ using the image recording system 1. For this purpose, it would also be conceivable, for example, to use a spectrally tunable light source 12 instead of the time-modulated LEDs in FIG. 4.

FIG. 5 shows a further approach according to the invention: Here, use is made of a broadband white light source 12 which thus provides spectrally broad illumination light 15, but different color maps 22 are used as a target 22 in each case, with the result that the calibration light 14 reflected by the respective target 22 can be changed spectrally (by replacing the respective target 22). If both the intensity of the white light source 12, that is to say its spectral intensity distribution, and the spectral reflection properties of the respective color map 22 are known exactly, respective correction values 16 can also be captured/calculated in this manner, as illustrated in FIG. 5. These correction values 16 can then be taken into account subsequently in a meaningful manner in an imaging mode by the visualization system 1 for more precise subsequent subspectral imaging.

As an alternative to the use of such color maps, LEDs with a respective specific spectral distribution/emission color can also be used, for example, to generate suitable calibration light. In this case, it can be advantageous to use a diffuse target which does not carry out any spectral selection, but rather ensures by its diffuse properties that the respective light from the LED hits the visualization system 1 with a wide angular distribution. This applies in general, not only to the use of narrowband light sources, but also to the use of broadband sources for generating calibration light.

Since the intensity distribution of the light source 12 is important for the correct calculation of the correction values 16, a subspectral characteristic of the light source 12 can be sensorily captured in advance in the example shown in FIG. 5, for example using an external measuring device specifically provided for this purpose. This characteristic can then either be stored in the memory 10 together with the subspectral correction data 11 (so that this characteristic can be taken into account by the visualization system 1 in the imaging mode) or this characteristic can already be taken into account when calculating the correction data 11.

However, the intensity distribution of the light source does not necessarily have to be known beforehand and does not necessarily have to be captured by a measuring device either, for example if a signal ratio of at least two subspectra or a signal ratio between the subspectrum and the total spectrum is sensorily captured and used for correction.

Furthermore, as mentioned, parasitic effects can also be captured during calibration, for example in order to correct a measurement signal which should actually only be visible in a certain subspectrum or in the total spectrum, but in fact, due to manufacturing tolerances, can also be captured in another subspectrum, in which the signal should not appear. Accordingly, in such a case, this parasitic signal should be subtracted with a certain factor in order to avoid falsifying the subspectral image signals. Even with such a calibration, however, the light intensity does not necessarily have to be known, but rather it may be sufficient to observe the relative signals in two subspectra or relative to the total spectrum and to represent them in the correction data.

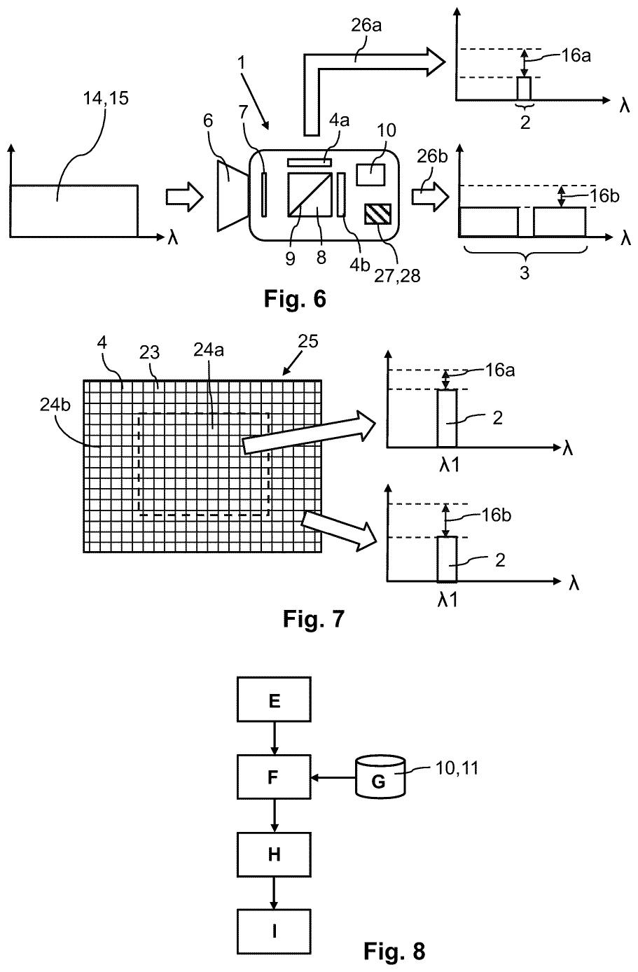

FIG. 6 illustrates that it is also possible, for example, to spatially separate a certain subspectrum 2 from a total spectrum 3 by means of a beam splitter 8 with a spectrally selective beam splitter layer 9, with the result that the subspectrum 2 can be spatially separated and can be thus be captured separately from the total spectrum 3 using a separate image sensor 4a of the visualization system 1. As a result, a spectral gap (cf. the lower right graph in FIG. 6) is formed after transmission through the beam splitter layer 9, in which case the remaining part of the total spectrum 3 reaches the image sensor 3b.

In the visualization system 1 according to the invention illustrated in FIG. 6, for example, the second image sensor 4b can record white light images, while the first upper image sensor 4a selectively sensorily captures only the narrowband subspectrum 2. A typical application of such a situation is, for example, fluorescence light imaging which takes place at the same time as parallel VIS imaging and takes place with fluorescence wavelengths in the subspectrum 2. In this case, for example, the optical filter 7 can remove used excitation light from the image transmission chain of the visualization system 1.

In the situation shown in FIG. 6, a calibration method according to the invention can therefore also be carried out with broadband reference light 15 (left graph) whose subspectral components, which are located in the subspectrum 2, thus serve as calibration light 14 in order to be able to capture the desired subspectral correction data 11 (based on the illustrated correction values 16a) with the image sensor 4a and to store them in the memory 10. Likewise, corresponding correction values 16b can also be sensorily captured with the image sensor 4b for the image transmission chain used for VIS imaging (at the bottom of FIG. 6) and stored in the memory 10.

FIG. 7 shows a further possibility of how a calibration method according to the invention can be configured: Shown here is an image sensor 4 of a visualization system 1 configured according to the invention, the active sensor surface of which has numerous pixels 23 that can be used to capture a subspectral image 25 overall. The pixels in the center of the image sensor 4 define an inner image area 24a which is surrounded by an outer image area 24b.

Since the subspectral sensitivity is typically subject to fluctuations over the object field (for example because the spectrally selective beam splitter 8 shown in FIG. 6 attenuates imaging beams more or less strongly depending on the different angle of incidence or because the effective sensitivity fluctuates due to a different spectral sensitivity of the image sensor 4 depending on the picture element/position of the respective pixel 23), provision may be made, as shown in FIG. 7, for different subspectral correction data 11 to each be sensorily captured in the form of respectively different correction values 16a, 16b for the different image areas 24a, 24b, in a spatially resolved manner with the aid of the image sensor 4 and to then be stored in the form of location-dependent correction data 11. In other words, for example, a corresponding correction value has been respectively captured/defined for each pixel 23 or for local groups of pixels 23 of the image sensor 4, i.e. based on a measurement, as illustrated in FIG. 7. If subspectral image processing is then subsequently carried out in an imaging mode by the system 1 (in which respective subspectral image signals are then captured with the pixels 23 of the image sensor 4), a precisely defined subspectral correction value 16 can be respectively used/taken into account in this case for different picture elements in the processing of the subspectral image signals (by way of the processing unit 28). Thus, the subspectral correction carried out for the respective pixel 23 or the respective pixel group can be more or less severe over the subspectral image 25. It goes without saying that this approach can further improve the subspectral correction because it is no longer carried out globally, but rather in a spatially resolved manner (i.e. on the basis of the pixel position on the image sensor).

FIG. 8 schematically illustrates the use of a method according to the invention to set up a visualization system 1 for subsequent subspectral image processing: Step G=Correction data 11 which have been determined using a calibration approach according to the invention (e.g. as described with reference to FIG. 1) and calculated by a calculation unit 27 of the system are stored in a memory 10; E=An image, preferably a white light image, which is based on image signals from an image sensor 4 of the visualization system 1 is recorded using the visualization system 1, and subspectral image signals are also sensorily captured (either spatially or temporally) separately, in particular with a second image sensor; F=A processing unit 28 of the visualization system 1 corrects the separately captured subspectral image signals with the aid of the correction data 11 retrieved from the memory 10 as part of subspectral image processing. Subsequently, the subspectral image data corrected in this way can already be visualized on a display unit. Here, the subspectral image data can be used, in particular in a step H, by the processing unit 28 to calculate a subspectral representation (as possible additional image information) (e.g. a false color representation of a 2D distribution of a local oxygen saturation). In a subsequent step I, this subspectral representation can be displayed together with the recorded image/white light image, in particular by fusing the white light image with the subspectral representation. In this way, additional image information based on the subspectral image data can be visualized together with the white light image, e.g. as a superimposition or as an annotation. The correction of the subspectral image data with the aid of the correction data 11 ensures that the additional image information can meet requirements for accuracy (e.g. highly accurate determination of the local oxygen concentration).

In summary, a method for a visualization system 1 is provided, with which the accuracy and reliability of subspectral image signal processing or imaging can be improved. This subspectral image processing or imaging can be used in particular to obtain not only more broadband imaging but also additional image information which in turn is obtained exclusively from light which is in a subspectrum 2, wherein the subspectrum 2 is part of a spectrally broader total spectrum 3 used overall for imaging. The method can provide for respective subspectral correction data 11 to be captured for individual different wavelengths from the subspectrum 2 and stored in a memory 10 (e.g. of the visualization system 1), so that these correction data 11 can be taken into account in the subsequent subspectral imaging, in particular by the visualization system 1 used.

### LIST OF REFERENCE SIGNS

1 Visualization system (e.g. in the form of an endoscopy or microscopy system; this may also comprise associated components such as control devices, light sources and the like or a remote system (cloud))
2 Subspectrum (one or more sections of 3)
3 Total spectrum (=total wavelength range used overall for imaging)
4 Image sensor
5 Passive optical components
6 Optical lens
7 Optical filter
8 Spectrally selective beam splitter
9 Beam splitter layer (of 8)
10 (Electronic) memory (for storing 11)
11 Subspectral correction data
12 Light source (subcomponent of 1)
13 Calibration light source
14 Calibration light
15 Reference light/illumination light
16 Correction value
17 Reference curve, reference measured values
18 Actually measured values
19 Measurement signal (recorded within 2)
20 Values actually measured with 1
21 Reference value
22 Target (e.g. color map)
23 Pixels (of 4)
24 Image areas (of 25)
25 Image
26 Image or measurement signals
27 Calculation unit (for calculating 11)
28 Processing unit (configured to process subspectral image signals)

1. A method for setting up a visualization system (1) for subsequent subspectral image processing, the method comprising:
in the subspectral image processing, sensorily capturing and processing a subspectrum (2), as part of a total spectrum (3) sensorily captured overall using the visualization system (1) for imaging, in a form of subspectral image signals separately, spatially or temporally separated, from the rest of the total spectrum (3);
calculating from the subspectral image signals, additional image information which is adapted to be superimposed on a white light image generated with the visualization system (1);
in a calibration step, sensorily capturing calibration light (14) with a wavelength of the subspectrum (2) and with a known intensity in a form of subspectral measurement signals (19) using the visualization system (1);
calculating subspectral correction data (11) from the subspectral measurement signals (19) taking into account reference signals generated by reference light (15);
storing the subspectral correction data (11) are stored in a memory (10) which is adapted to be read out using the visualization system (1) during subsequent processing of the subspectral image signals; and
taking into account a result that the correction data (11) in a subsequent calculation of the additional image information.

2. The method as claimed in claim 1, wherein a remainder of the total spectrum (3) or an entirety of the total spectrum (3) is sensorily captured using a first image sensor (4a) and the subspectrum (2) is sensorily captured using a separate second image sensor (4b).

3. The method as claimed in claim 1, wherein a remainder of the total spectrum (3) and the subspectrum (2) are captured a same image sensor (4), but in a spatially separated manner in different pixels of the image sensor (4) and/or temporally separately from one another at different times.

4. The method (1) as claimed in claim 1, wherein, as part of the calibration step the method further comprises sensorily capturing a spectral characteristic of a light source (12) of the visualization system (1), and is storing the special characteristic together with the subspectral correction data (11), and
taking into account the spectral characteristic when using the light source (12), in subsequent subspectral imaging when processing subspectral image signals.

5. The method (1) as claimed in claim 1, wherein the subspectral correction data (11) are captured or calculated in a spatially resolved manner for different image areas (24a, 24b) and/or for different picture elements and are stored as location-dependent correction data (11), and the method further comprises
taking into account different subspectral correction values (16) for the different picture elements in subsequent subspectral image processing.

6. The method (1) as claimed in claim 1, wherein the visualization system comprises a camera head and a plurality of endoscopes to be used with the camera head, and the method further includes capturing and storing separate subspectral correction data (11) for each of the endoscopes, and the method further comprises
making an endoscope-specific spectral correction of the subspectral image signals during subsequent use of the respective endoscope with the camera head.

7. The method (1) as claimed in claim 1, wherein all components of the visualization system (1), which are used in the subsequent subspectral imaging, are also used to capture the subspectral measurement signals aided by the calibration light and/or a calibration target (22).

8. The method (1) as claimed in claim 1, wherein the subspectral correction data (11) cover at least two different spectral ranges of the subspectrum (2), and the respective correction data (11) in the at least two different spectral ranges differ in terms of respective spectral resolution, measured in nm.

9. The method as claimed in claim 1, wherein, in the calibration step, respective correction data are generated for at least two different subspectra (2a, 2b) which are intended to be captured and processed later, separately from each other, as part of the subspectral image processing, based at least on a ratio of two of the subspectral measurement signals (19) which are sensorily captured in the at least two different subspectra in the calibration step using the visualization system (1).

10. The method as claimed in claim 1, wherein the correction data (11) comprise a parasitic correction value which is adapted to be used in the subsequent subspectral image processing to compensate for a parasitic subspectral image signal, and the calibration light (14) which is spectrally outside that subspectrum (2), during the subsequent processing of which the parasitic correction value is taken into account, is sensorily captured use in the calibration step.

11. The method (1) as claimed in claim 1, wherein the calibration light is generated by
a plurality of time-modulated calibration light sources (13),
a spectrally modulatable light source (12), or
a broadband light source (12) in conjunction with a plurality of targets (22).

12. The method (1) as claimed in claim 1, wherein the visualization system (1) enables a plurality of subspectral imaging modes in at least two different subspectra (2a, 2b), and The method further comprises capturing and storing respective subspectral correction data (11a, 11b) for each of the two different subspectra (2a, 2b).

13. A method of processing subspectral images, comprising:
providing a visualization system (1) comprising a camera head and at least one associated endoscope, for subspectral imaging;
carrying out subspectral imaging at a same time as or in temporal alternation with further spectrally broader imaging, using the visualization system (1);
correcting subspectral image signals generated during the subspectral imaging using the visualization system (1) using subspectral correction data (11) measured by a calibration method as claimed in claim 1 using the visualization system used (1);
wherein the subspectral image signals are based only on a subspectrum (2) as part of a spectrally broader total spectrum (3) used overall for imaging and/or represent said subspectrum (2).

14. The method as claimed in claim 13, further comprising applying different subspectral correction values (16a, 16b) when correcting the subspectral image signals depending on a location or position of a picture element associated with the respective subspectral image signal, such that a subspectral correction of varying degrees is made over a subspectral image (25) which is captured using the visualization system (1).

15. The method as claimed in claim 13, further comprising calling the stored subspectral correction data (11) when correcting the subspectral image signals and are processed further by interpolation or extrapolation and/or taking into account a current measured value of an environmental factor such as an ambient temperature to form an extended and/or adapted correction data set, which correction data set is used for the subspectral correction.

16. A visualization system (1), comprising
a calculation unit (27);
a processing unit (28); and
at least one image sensor (4),
wherein the calculation unit (27) is configured, in a calibration step, to calculate subspectral correction data (11) from subspectral measurement signals (19) based on sensory capture of calibration light (14), and
the processing unit (28) is configured to process subspectral image signals from the at least one image sensor (4) in an imaging mode, taking into account the subspectral correction data (11), to achieve improved subspectral imaging and/or a more accurate calculation of additional image information.

17. The visualization system (1) of claim 16, further comprising a camera head and at least one associated endoscope.

18. The visualization system (1) of claim 16, wherein the processing unit (28) is configured to process the subspectral image signals in real time and the visualization system (1) is set up to additionally and simultaneously generate live white light images from signals from the at least one image sensor (4).
